(19) United States
(12) Patent Application Publication
(10) Pub. No.: US 2015/0025666 A1
(43) Pub. Date: Jan. 22, 2015

(54) THREE DIMENSIONAL PRINTED REPLICAS OF PATIENT'S ANATOMY FOR MEDICAL APPLICATIONS

(71) Applicant: Children's National Medical Center, Washington, DC (US)

(72) Inventors: Laura Olivieri, Bethesda, MD (US); Axel Krieger, Alexandria, VA (US); Craig Sable, Washington, DC (US); Peter Kim, Washington, DC (US); Xin Kang, Hyattsville, MD (US); Dilip Nath, Bethesda, MD (US); Yue-Hin Loke, Washington, DC (US); Carolyn T. Cochenour, Washington, DC (US)

(73) Assignee: Children's National Medical Center, Washington, DC (US)

(21) Appl. No.: 14/333,234

(22) Filed: Jul. 16, 2014

Related U.S. Application Data
(60) Provisional application No. 61/846,890, filed on Jul. 16, 2013.

(51) Int. Cl. B29C 67/00; G06F 17/50

(52) U.S. Cl. CPC B29C 67/0088; G06F 17/50
USPC 700/98

(57) ABSTRACT

A system and method of creating a 3-dimensional (3D) replica of a patient's anatomy. The method includes acquiring 3D echo images of the patient's anatomy using ultrasound waves, selecting a filter that reduces noise in the 3D echo images, selecting a segmentation algorithm to segment the filtered 3D echo images, selecting at least one additional segmentation algorithm to subsequently segment the segmented 3D echo images, creating a 3D digital model, and outputting the 3D digital model as the 3D replica of the patient's anatomy. The method also includes acquiring other 3D images using MRI/CT scans, creating another 3D digital model, determining a scaling factor to scale the other 3D digital model to correspond to a size of the 3D digital model created using ultrasound waves, combining the 3D digital model and the other 3D digital model, and outputting the combined 3D digital models.

### CROSS-REFERENCE TO RELATED APPLICATIONS

This application is based upon and claims the benefit of priority under 35 U.S.C. §119(e) from U.S. Ser. No. 61/846,890, filed Jul. 16, 2013, the entire contents of which are incorporated herein by reference.

### FIELD OF THE INVENTION

This disclosure is related to three dimensional (3D) printing of a physical replica of anatomical features, derived from medical images. In particular, this invention relates to creating accurate replicas of a patient's anatomy from 3D echo images (i.e., 3D ultrasound images).

### BACKGROUND

Pediatric heart complications are not uncommon, and congenital heart disease occurs quite frequently. Congenital heart disease affects almost 1% of all live births and 25% of these patients need surgery in order to live to be a year old. For adult cases, it is estimated that 83.6 million American adults have one or more types of cardiovascular disease. These types of heart diseases include high blood pressure, coronary heart disease, and hypertension, amongst others. Congenital heart defects in adults affect 650,000 to 1.3 million adults. In 2009, a study revealed that cardiovascular disease, including congenital heart defects, accounted for 1 in 3 deaths among American adults. Cardiovascular diseases have been the leading cause of deaths in the United States every year since 1900, with the exception of 1918. The National Center for Health Statistics proposed that life expectancy could increase by a total of 7 years if major cardiovascular problems were eliminated.

The diagnosis and management of structural heart diseases is largely driven by two-dimensional (2D) imaging methods. Nearly every type of heart defect occurs with a spectrum of severity, and structure ties directly to function. Physiology can be predicted based on the appearance of the heart on two-dimensional echocardiography (cardiac ultrasound). Cardiologists and cardiovascular surgeons rely on mental conversion of 2D data into a 3D understanding of the spatial relationships of intracardiac structures. However, congenital heart disease is a three-dimensional problem and two dimensional methods often lack critical spatial information. As imaging technology advances, opportunities arise to improve accuracy and quality of current diagnostic methods. Newer echocardiography transducers, coupled with advanced software and hardware make display of 3D rendered images of the heart possible. Although this is a significant advancement, it still falls short of providing a precise roadmap for cardiovascular surgery.

During open-heart surgeries, every minute spent on cardiopulmonary bypass by the patient is precious. Long-term developmental outcome studies of patients with congenital heart disease which required surgery have shown that developmental outcomes correlate strongly with amount of time spent on cardiopulmonary bypass and deep hypothermic circulatory arrest. Innovations which have the potential to decrease bypass time are valuable and have the potential for direct benefit to the patient. The same is true in the cardiac catheterization laboratory. Studies have shown damage to the chromosomes in patients who have been exposed to ionizing radiation. Any tool which can aid in procedural planning and decrease procedure time and therefore radiation exposure has the potential for benefit to the patient. Providing an interventional cardiologist or surgeon with a printed out model of a heart demonstrating a specific defect prior to the procedure may decrease procedure time and complication rates.

For example, many infants, children, and adults with congenital heart disease require not just one but multiple procedures to palliate their congenital heart disease. There is potential for magnitudes of benefit utilizing 3D models prior to each procedure to ensure that surgeons, cardiologists, and cardiac interventionalists are fully informed in the procedures that they choose for their patients, as well as the procedures they perform.

Other invasive surgeries and interventions could benefit from the use of a 3D model acquired through ultrasonic imaging. For example, using fetal images, from obstetric ultrasounds, to create 3D Models could aid in assessing function, educate parents and clinical personnel, and prepare for intervention. Among other things, ultrasounds can examine the liver, thyroid, gall bladder, prostate, ovaries, testes, breasts, and joints, too. These images, in particular liver and reproductive images, could be used to generate models of these areas. This could apply to organ transplants, replacements, and other invasive procedures, such as complex thoracic surgeries.

Presenting a cardiothoracic surgeon a two dimensional echo, Magnetic Resonance Imaging (MRI) or Computed Tomography (CT) is a good way to demonstrate cardiovascular defects. Presenting a surgeon with a three dimensional replication of the heart they are about to perform surgery on is a powerful method for procedural planning. There are several 3D imaging modalities available and in clinical practice that can serve to provide printed replica of anatomy. Typically, this 3D imaging data is acquired from a high-resolution modality, such as Magnetic Resonance Imaging (MRI) or Computed Tomography (CT), to make high-quality reconstructions; however intravenous (IV) contrast, sedation, and radiation are involved when performing these diagnostic procedures in children. There appear to be no reports of 3D printing of echocardiography-based datasets. Ultrasound provides several advantages over MRI and CT. For example, the technology is portable, readily available, involves no radiation, and can be done with no or conscious sedation. Ultrasound also provides excellent temporal resolution and allows investigating rapidly moving parts, such as cardiac valves.

In addition to using the replicas of anatomy for procedural planning, they can also be used as a teaching tool in patient and physician education. Internal cardiac structures will be able to be seen in a much more hands on way, and disease and heart complications can be more fully understood with the aid of the models. These models could also be used for general research studies regarding how the heart progresses after surgery, say from taking a model before and after surgery. Having a physical, tangible item to work with in the classroom expands student and physician knowledge and contributes to the progression of modern medicine.

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly or impliedly admitted as prior art against the present invention.

### BRIEF DESCRIPTION OF THE DRAWINGS

A more complete appreciation of the disclosed embodiments and many of the attendant advantages thereof will be readily obtained as the same becomes better understood by reference to the following detailed description when considered in connection with the accompanying drawings, wherein:

FIG. 1 illustrates a flow diagram of an exemplary method of creating a 3D replica of a patient's anatomy using ultrasound waves.

FIG. 2 illustrates unfiltered and filtered 3D echo images.

FIG. 3 illustrates segmented 3D echo images, a corresponding 3D ultrasound digital model, and a corresponding 3D replica.

FIG. 4 illustrates a 3D ultrasound replica of the present invention fused with a 3D general replica.

FIG. 5 illustrates a flow diagram of an exemplary method of creating a 3D replica of a 3D general digital model and a 3D ultrasound digital model.

FIG. 6 illustrates an exemplary system of creating a 3D replica of a patient's anatomy.

FIG. 7 illustrates an exemplary computing system.

### DETAILED DESCRIPTION

The present disclosure describes a method of outputting a 3-dimensional (3D) replica of a patient's anatomy. The method includes acquiring 3D echo images of the patient's anatomy using ultrasound waves and using specific acquisition parameters that optimize a quality of the 3D echo images of the patient's anatomy, selecting, using processing circuitry, a filter based on a type of the patient's anatomy that reduces noise in the 3D echo images by filtering the 3D echo images using the selected filter, selecting, using the processing circuitry, an initial segmentation algorithm to initially segment the filtered 3D echo images based on one of a size of the patient, a quality determination of the filtered 3D echo images, and a type of defect of the patient's anatomy, initially segmenting each of the filtered 3D echo images, selecting, using the processing circuitry, at least one second segmentation algorithm, different from the initial segmentation algorithm, to subsequently segment the initially segmented 3D echo images, subsequently segmenting each of the initially segmented 3D echo images, creating a 3D digital model of the subsequently segmented 3D echo images, and outputting the 3D digital model as the 3D replica of the patient's anatomy.

The method further includes an embodiment where the outputting further includes one of printing, using a 3D printer, the 3D digital model as the 3D replica of the patient's anatomy, and displaying, on a display, the 3D digital model as the 3D replica of the patient's anatomy.

The method further includes smoothing, wrapping, and hole-filling the subsequently segmented 3D echo images prior to said creating the 3D digital model.

The method further includes an embodiment where the patient's anatomy includes a heart or a portion of the heart, and where the specific acquisition parameters include imaging of the heart or the portion of the heart in one phase of a cardiac cycle.

The method further includes an embodiment where said selecting the filter includes selecting at least one of a spatial, frequency, and wavelet filter to reduce noise in the 3D echo images.

The method further includes an embodiment where the filter is selected based on a type of the patient's anatomy.

The method further includes an embodiment where the initial segmentation algorithm is one of simple threshold, region growing, dynamic region growing, manual segmentation, and image interpolation.

The method further includes an embodiment where the patient's anatomy includes a heart or a portion of the heart and wherein said selecting the initial segmentation algorithm to initially segment the 3D echo images is further based on a heart rate of the patient.

The method further includes an embodiment where the second segmentation algorithm is one or more of thresholding, region growing, dynamic region growing, and hand-segmentation.

The method further includes an embodiment where the subsequently segmented 3D echo images are converted to a StereoLithography-file (STL-file) format.

The method further includes an embodiment where different sections of the patient's anatomy are printed with different materials, different colors, and/or different levels of transparency.

The method further includes electro-polishing the 3D replica of the patient's anatomy to clarify internal features of the 3D replica of the patient's anatomy.

The method further includes an embodiment where the different materials includes one or more of High-impact plastics, High-temperature plastics, Rubber-like materials, Silicones, Biodegradable polymers, Biocompatible polymers, Bioactive materials, Biologic materials, Ceramics, Fused powders, Metals, Flexible hard plastics, and Bone-like composites.

The method further includes an embodiment where the initial segmentation algorithm and the second segmental algorithm are manual, semi-automated, and/or automated.

The method further includes acquiring other 3D images of a reference patient's anatomy using MRI/CT scans, the reference patient's anatomy corresponding to the patient's anatomy, creating, using processing circuitry, another 3D digital model of the other 3D images after filtering and segmenting the other 3D images, determining, using the processing circuitry, a scaling factor to scale a first size of the other 3D digital model of the reference patient's anatomy to correspond to a second size of the 3D digital model of the patient's anatomy, scaling, using the processing circuitry, the first size of the other 3D digital model using the scaling factor, cutting, using the processing circuitry, a first portion of the other 3D digital model, the first portion corresponding to portion of the patient's anatomy represented by the 3D digital model, and replacing the first portion with the 3D digital model by combining the 3D digital model and the other 3D digital model, and outputting the combined other 3D digital model and 3D digital model to generate a combined 3D replica of the patient's anatomy.

The method further includes an embodiment where the outputting further includes printing, using a 3D printer, the combined 3D replica of the patient's anatomy, and where the other 3D digital model and the 3D digital model are printed using different materials.

The method further includes an embodiment where the other 3D digital model is printed using a transparent material and the 3D digital model is printed using an opaque material or vice versa.

The method further includes an embodiment where different portions of the patient's anatomy are subsequently segmented using different segmentation algorithms.

The present disclosure also describes a system of outputting a 3-dimensional (3D) replica of a patient's anatomy. The system includes processing circuitry configured to select a filter based on a type of the patient's anatomy that reduces noise in 3D echo images of the patient's anatomy by filtering the 3D echo images using the selected filter, the 3D echo images being acquired from a first 3D scanning apparatus using ultrasound waves, select an initial segmentation algorithm to initially segment the filtered 3D echo images based on one of a size of the patient, a quality determination of the 3D echo images of the filtered 3D echo images, and a type of defect of the patient's anatomy, initially segment each of the filtered 3D echo images, select at least one second segmentation algorithm, different from the initial segmentation algorithm, to subsequently segment the initially segmented 3D echo images, subsequently segment each of the initially segmented 3D echo images, and create a 3D digital model of the subsequently segmented 3D echo images to be output as the 3D replica of the patient's anatomy.

The system further includes an embodiment where the processing circuitry is configured to create another 3D digital model of other 3D images of a reference patient's anatomy after filtering and segmenting the other 3D images, the reference patient's anatomy corresponding to the patient's anatomy and the other 3D images being acquired from a second 3D scanning apparatus using MRI/CT scans, determine a scaling factor to scale a first size of the other 3D digital model of the reference patient's anatomy to correspond to a second size of the 3D digital model of the patient's anatomy, scale the first size of the other 3D digital model using the scaling factor, and cut a first portion of the other 3D digital model, the first portion corresponding to portion of the patient's anatomy represented by the 3D digital model, and replace the first portion with the 3D digital model by combining the 3D digital model and the other 3D digital model to output the combined other 3D digital model and 3D digital model as a combined 3D replica of the patient's anatomy.

The system further includes an embodiment where different portions of the patient's anatomy are subsequently segmented using different segmentation algorithms.

The present disclosure also describes a non-transitory computer-readable storage medium storing computer-readable instructions that, when executed by a computer, cause the computer to execute a method of outputting a 3-dimensional (3D) replica of a patient's anatomy. The method including acquiring 3D echo images of the patient's anatomy using ultrasound waves and using specific acquisition parameters that optimize a quality of the 3D echo images of the patient's anatomy, selecting, using processing circuitry, a filter based on a type of the patient's anatomy that reduces noise in the 3D echo images by filtering the 3D echo images using the selected filter, selecting, using the processing circuitry, an initial segmentation algorithm to initially segment the filtered 3D echo images based on one of a size of the patient, a quality determination of the filtered 3D echo images, and a type of defect of the patient's anatomy, initially segmenting each of the filtered 3D echo images, selecting, using the processing circuitry, at least one second segmentation algorithm, different from the initial segmentation algorithm, to subsequently segment the initially segmented 3D echo images, subsequently segmenting each of the initially segmented 3D echo images, creating a 3D digital model of the subsequently segmented 3D echo images, and outputting the 3D digital model as the 3D replica of the patient's anatomy.

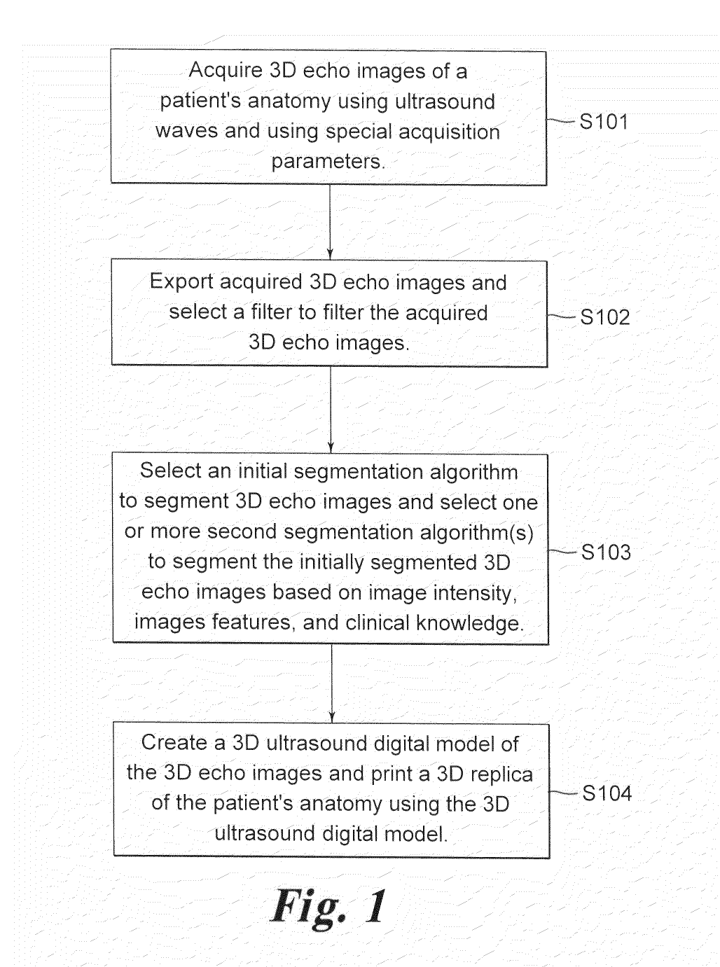

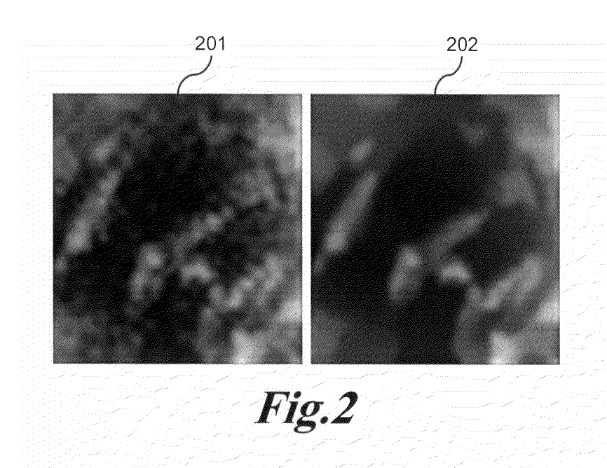

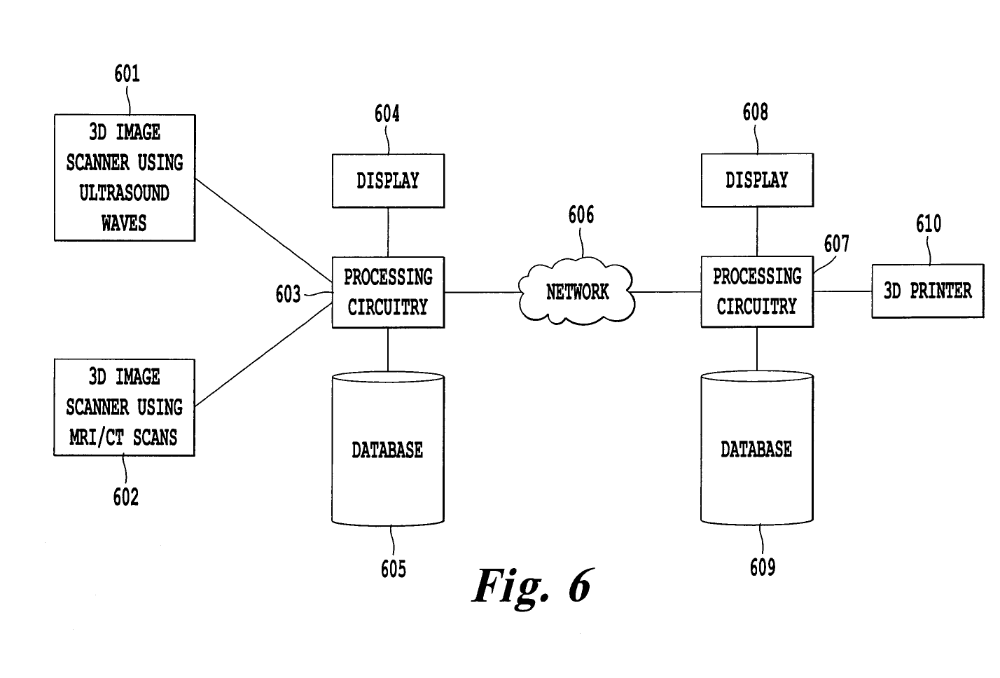

FIG. 1 illustrates an exemplary workflow for converting 3D echo images (i.e., 3D ultrasound images) into a patient anatomy replica (i.e. a 3D replica of a patient's anatomy), according to one aspect of the present disclosure. In Step S101 of FIG. 1, 3D echo images of a patient's anatomy are acquired using ultrasound waves and using special acquisition parameters to optimize acquisition for filtering, segmenting, and printing of the patient's anatomy. These special acquisition parameters are described further with reference to FIG. 2. Step S101 can be performed using a 3D image scanner 601, which is described below with reference to FIG. 6. In Step S102 of FIG. 1, the acquired 3D images are exported and a filter is selected to filter noise from the 3D echo images (such as noise from ultrasonic sound waves and from other sources of interference) to enhance the 3D echo images. Several filtration techniques may be used, which are further described with regard to FIG. 2. In Step S102, the 3D echo images can be converted into DICOM format. DICOM or Digital Imaging and Communications in Medicine is a standard for handling, storing, printing, and transmitting information in medical imaging.

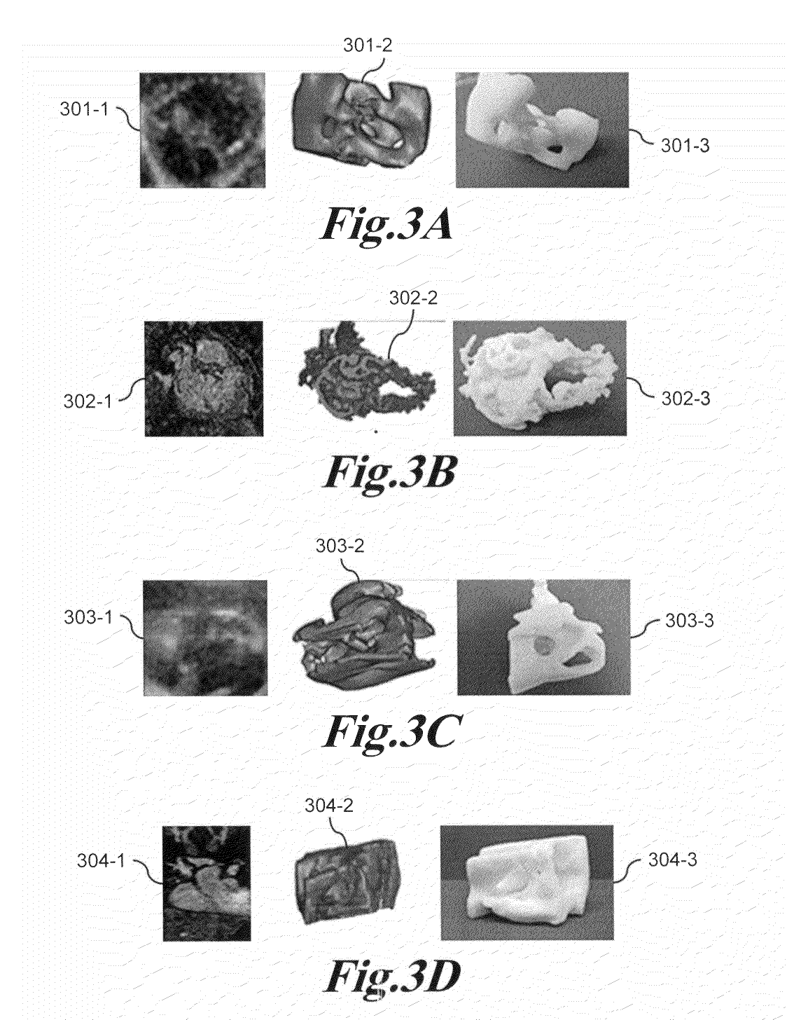

Further, in Step S103 of FIG. 1, an initial segmentation algorithm is selected to initially segment the 3D echo images. Thereafter, a subsequent segmentation algorithm(s) is selected to segment the initially segmented 3D echo images based on image intensity, image features, and/or clinical knowledge. The segmentation is performed in a 2-step segmentation process using an initial segmentation algorithm and then using one or more subsequent segmentation algorithm(s) to segment the 3D echo images. Segmentation techniques are further described with reference to FIG. 3. Finally, in Step S104 of FIG. 1, a 3D replica of the patient's anatomy is printed using a 3D printer. The 3D echo images are first converted to a 3D ultrasound digital model before being printed by the 3D printer. Steps S102 (including filtering of 3D echo images), S103 (including segmenting of 3D echo images), and part of S104 (i.e., creating the 3D ultrasound digital model) may be performed by processing circuitry 603 (for example, a central processing unit), which is described with reference to FIG. 6. Additionally, Step S104 (i.e., creating/printing a 3D replica of the patient's anatomy) can be performed using a 3D printer 610, which is also described with reference to FIG. 6.

Image Acquisition and Filtering

FIG. 2 illustrates an exemplary 3D echocardiographic image (i.e., 3D echo image/3D ultrasound image) of a four chamber view of a patient's heart. The image 201 on the left of FIG. 2 illustrates an unfiltered 3D echocardiographic image and the image 202 on the right of FIG. 2 illustrates a filtered 3D echocardiographic image. In an exemplary aspect of the present disclosure, 3D echocardiographic images are obtained using specialized 3D probes and post-processing software. Alternatively, 3D echocardiographic images can be obtained by stitching together a series of 2D echocardiographic images. For 3D cardiac echo imaging, transesophageal and transthoracic imaging are used. For example Philips X7-1, X7-2 probes, which are smaller than usual are used so that 3D scans can be performed on smaller regions. One example of post-processing software is QLAB, a commercial post-processing software from Philips Medical. Further, in an exemplary aspect of the present disclosure, acquisition parameters are set to optimize spatial resolution of the 3D echocardiographic images, such as imaging a heart in one phase of the cardiac cycle only. Additionally, the gains, depth, focus, and field of view can be adjusted to optimize image quality of the 3D echocardiographic images. For example, image quality of a ventricular septal defect (VSD) of the heart is better with a lower gain and image quality of complete canals or other tissues with atrioventricular valves benefit from slightly higher gains. Other acquisition parameters that can be adjusted include temporal and spatial resolution. For example, fast moving objects such as valves are better imaged with higher temporal resolution. The setting of acquisition parameters to optimize the image quality of the 3D echo images is an example of a filtering method to de-noise 3D echocardiography images.

In one embodiment of the present disclosure, specialized filters such as spatial, frequency, and wavelet filters can be used. Spatial filters work in the image space, with Gaussian smoothing filters as an example. Filters can also operate in frequency space, utilizing Fourier analysis. Wavelet filters (e.g. the translation invariant wavelet thresholding) operate in both the time and frequency spaces. For example, spatial, non-local means filtering can be used to optimize the image quality of the 3D echo images. Non-local means is an algorithm in image processing for image denoising. Unlike “local mean” filters, which take the mean value of a group of pixels surrounding a target pixel to smooth the image, non-local means filtering takes a mean of all pixels in the image, weighted by how similar these pixels are to the target pixel. This results in much greater post-filtering clarity, and less loss of detail in the image compared with local mean algorithms.

The goal of filtering is to increase the contrast to noise between real anatomy and the surrounding. Ultrasound images display the anatomy (for example, myocardium) as a bright signal and the blood as dark. But these ultrasound images suffer from a lot of noise, typically granular speckle noise. The spatial, non-local means filter works really well in suppressing speckle noise with very little loss of anatomical detail. As a result, the blood-filled intra-cardiac space becomes really dark while the border remains sharp. This makes signal intensity based segmentation, for example, by thresholding easy.

In contrast, MRI and CT scans, which are typically used for creating 3D models of the heart, display the blood as a bright signal and don't show the anatomy (myocardium). What is segmented with MRI and CT scans is the intracardiac volume. The contrast is thus reversed compared to echo images. Other filters with different parameters are used to suppress noise resulting from MRI and CT scans. Based on experimentation by the inventors, the spatial non-local means filter appeared to work the best with regard to 3D echo images. The filters are selected to give the best contrast to noise ratio without blurring of the anatomy. The filters can be selected based on a diagnosis of a problem with the patient or based on a type of anatomy (or based on a portion of the type of anatomy) of the patient at issue. For example, if the problem is with the heart, the filter would need to filter through a large pool of blood for better image quality of the heart, but if the problem is with the liver, then the filter may not need to filter through as much blood. Accordingly, the selection of filters is dependent on what is creating the contrast. The amount of filtering (iterations) can be adjusted based on an output of particular patient images by the filter. The number of filter iterations can be increased until noise is well suppressed and can be stopped when blurring of the patient's anatomy occurs. The filters can be selected by processing circuitry 603 or can be selected manually. A predetermined set of filters to be used for different portions of a patient's anatomy are stored in a database. Further, a number of filter iterations can be determined by processing circuitry 603 based on an amount of noise in the 3D echo images or can be determined manually. For example, if the noise is above a certain predetermined threshold, the processing circuitry 603 will continue to perform filtering until the noise level in the 3D echo images is reduced to a number below the predetermined threshold.

These filters effectively reduce the speckle or noise, and leave behind only the anatomic boundaries of the various structures of the patient's anatomy. In the depicted example of FIG. 2, one can appreciate the decrease in noise in the blood pool of 3D echo images between an unfiltered 3D echo image (image 201 on the left of FIG. 2) and a filtered 3D echo image (image 202 on the right of FIG. 2). Spatial, non-local means filtering was used in FIG. 2 (image 202) to reduce the speckle or noise in the 3D echo image 202.

Segmentation and Model Fabrication

FIG. 3 shows an example of the segmentation and model fabrication process. The left most column (images 301-1, 302-1, 303-1, and 304-1) in FIG. 3 corresponds to segmented 3D echo images of four different patients with different types of ventricular septal defects. The middle column (images 301-2, 302-2, 303-2, and 304-2) in FIG. 3 represents a 3D ultrasound digital model corresponding to the 3D echo images on the left column. The left column shows segmented 3D echo images after initial segmentation. The middle column shows the 3D digital model after final segmentation and volume creation. Finally, the right most column (images 301-3, 302-3, 303-3, and 304-3) in FIG. 3 represents 3D printed plastic models corresponding to the 3D ultrasound digital model in the middle column of FIG. 3.

One embodiment of the present disclosure using specialized segmentation algorithms, such as thresholding, region growing, dynamic region growing, as well as hand-segmentation by an expert in cardiac anatomy and dysmorphology. For example, the segmentation techniques used in the present disclosure segments a bright myocardium and a black blood pool, whereas the techniques used for MRI and CT segmentations segment a bright blood pool and a uniform thickness to the blood pool in one embodiment or segment a bright blood pool and a non-uniform thickness to the blood pool in another embodiment to represent the myocardium. In a non-limiting embodiment of the present disclosure, a combination of segmentation algorithms can be used. For example, the dark blood pool around a VSD could be segmented in addition to a segmentation technique targeting the bright myocardium, and these two segmentation techniques can be combined. Segmentation algorithms can be selected by processing circuitry 603 based on a type of patient's anatomy or can be selected manually. For example, if aortic valve is at issue, processing circuitry 603 can retrieve data from a database to determine which segmentation algorithm to select for segmentation of the 3D echo images. A predetermined set of segmentation algorithms to be used for different portions of a patient's anatomy are stored in a database.

The thresholding technique exploits the differences in density of different tissues to select image pixels with a higher or equal value to a prescribed threshold value. For example, different tissues in the heart have different densities and based on a diagnosis of a defect in a patient's heart, the prescribed threshold value can be changed so that image pixels with regard to the defect in the patient's heart are displayed and other image pixels relating to the heart that have a value lower than the prescribed threshold value are not displayed.

Further, the region growing technique may be used after thresholding to isolate the areas which have the same density range. Region growing examines neighboring pixels of initial seed points (which are selected by a user) and determines whether the neighboring pixels should be added to the region. The process is performed iteratively to segment the image. For example seed points are selected inside the myocardium and inside the blood pool. The region growing segmentation techniques is performed iteratively to separate all image pixels into either myocardium or blood. Dynamic region growing is an extension of region growing. In addition to the seed points, a range of image parameters are selected for the image pixel to be recognized as the same as the seed points for dynamic region growing. Finally, manual editing (i.e., hand-segmentation by an expert in cardiac anatomy and dysmorphology) can be performed for local corrections and to remove noise from the segmented 3D echo images.

Segmentation of 3D echo images can be manual, semi-automated, and/or automated. 3D echo images can be segmented manually using hand-segmentation techniques by an expert in cardiac anatomy and dysmorphology. 3D echo images can also be automatically segmented using algorithms such as thresholding, region growing and dynamic region growing. Automatic segmentation techniques, such as thresholding are faster than semi-autonomous techniques such as region growing where the user defines seed points. The automatic segmentation techniques and the semi-autonomous techniques are a lot faster compared to manual techniques. However, often accuracy is better with manual techniques. Thus, whatever segmentation techniques provide the best results in the least amount of time are selected. Information on the best results in the least amount of time is stored in the database, allowing the processing circuitry 603 to review this information to select an appropriate segmentation algorithm(s). As noted above, 3D echo images can also be segmented semi-automatically by using a combination of manual and automatic segmentation algorithms (e.g., region growing).

Additionally, in a non-limiting embodiment of the present embodiments, an initial segmentation algorithm can be selected from simple threshold, region growing, dynamic region growing, manual segmentation, and image interpolation (Image interpolation is used to increase the image resolution, by using more pixels or voxels. This is helpful, for example, when there are larger spaces between image slices. Image information of neighboring slices is used to interpolate what a slice in between would look like and this provides added information) based on the size of the patient, the quality of the patient's ultrasound windows and images, the heart rate, and the type of defect being displayed. For example, region growing is used as a segmentation algorithm for 3D echo images of a VSD. A type of imaging (i.e., Echo images, MRI images or CT images) is also another factor used to determine an initial segmentation algorithm.

Following selection of the initial segmentation algorithm/method, the 3D image segmentation mask (the segmentation mask is the output of an initial segmentation process, i.e. a 3D model of the segmented data) is reined in with other subsequent segmentation algorithms. This 2-step segmentation technique is unique compared to MRI and CT scans because 3D modeling using MRI and CT scans segment only the blood pool. On the other hand, in the present disclosure, for example, the myocardium is segmented and accordingly, the intracardiac features can be enhanced by combining the segmentation of the myocardium with the segmentation of the blood pool performed by a different segmentation algorithm, since the blood pool is black. In other words, in an embodiment of the present disclosure, different portions of the patient's anatomy are segmented using different segmentation techniques to enhance, for example, the intracardiac features.

The initial segmentation algorithm is general, background segmentation. Subsequent segmentation algorithms are used for more refined segmentation of a single refined area of a patient's anatomy by using different segmentation techniques. This 2-step segmentation process improves detail in the important areas at issue. However, the subsequent segmentation (refined segmentation) cannot reasonably be used for the entire segmentation of the patient's anatomy as this would be too time consuming and may fail when trying to segment the general myocardium.

Finally, the segmented 3D echo images may require smoothing, wrapping and hole-filling to compensate for ultrasound-based artifacts within the 3D echo images. This can be performed using a smoothing process, where a computer program (which can be used to configure processing circuitry 603) fills in gaps and removes pixels without a neighbor. This process is typically done iteratively with the user defining the amount of smoothing (semi-autonomous). Too much smoothing would alter the anatomy, too little smoothing would result in gaps and clutter remaining. After creation of the 3D digital model, sometimes single voxels or group of voxels (dots in 3D space) are erroneously included in the model. By using an algorithm that removes voxels or group of voxels that are not connected to anything, this noise can be removed.

The segmented 3D echo images are converted into an STL-file (StereoLithography-file) format to generate a 3D digital model of the 3D echo images and prepared for the printer. Although creating a 3D digital model is described after the filtering and segmentation process, it should be noted that a 3D digital model can be created at any point during the process. For example, a 3D digital model using 3D echo images can be created before filtering and segmentation, or after filtering and before segmentation, or after filtering and after segmentation of the 3D echo images. Allowing 3D digital models to be created at different point in time allows a user to view the 3D digital model and determine whether additional filtering and/or segmentation needs to be performed prior to 3D printing. The 3D digital model of the 3D echo images can be used in procedural planning and education.

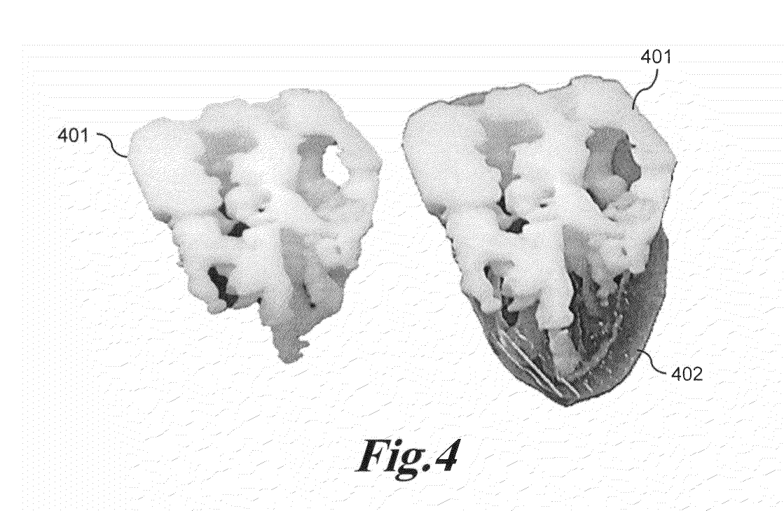

Once the heart replica is prepared and printed, a simulated operative or interventional technique can be fabricated as well. For example, as illustrated in FIG. 4, a patient specific 3D ultrasound replica 401 of a segment of a heart that is printed using the above-described techniques can be fused with a general replica 402 (i.e., of a different patient) of a heart created from MRI and/or CT scans to provide an anatomical context to a surgeon. Specifically, images of a standard heart are acquired using MRI or CT scans and the images are segmented to create a 3D general digital model of the heart. After creating a 3D general digital model of the heart and a 3D ultrasound digital model (see description above for generating a 3D digital model using ultrasound waves) of a segment of a patient's heart, major structures of the 3D general digital model and the 3D ultrasound digital model are identified and measured to provide a scaling factor to be applied to the 3D general digital model. In other words, if the 3D ultrasound digital model is a portion of a heart and the 3D general digital model is an entire heart, a scaling factor is determined based on the size of the portion of the heart in the 3D ultrasound digital model and a corresponding size of the same portion of the heart in the 3D general digital model. Once the 3D general digital model is scaled to that of the 3D ultrasound digital model, major structures (aortic valve, mitral valve, ventricular septum, etc.) are used to approximate and register data sets of both the 3D general digital model and the 3D ultrasound digital model.

For visualization purposes, a section of the 3D general digital model (section corresponding to the 3D ultrasound digital model) is cut off to visualize the defect present in patient's heart and the remaining section of the 3D general digital model is printed to form a 3D general replica 402 in transparent material to differentiate from the 3D ultrasound replica 401. The combined 3D general replica 402 and 3D ultrasound replica 401 can be printed as a single piece using different materials (i.e., 3D general replica 402 being printed using a transparent material and 3D ultrasound replica 401 being printed using an opaque material) or the 3D ultrasound replica 401 and the 3D general replica 402 can be printed separately using different materials and can be fit together afterwards. The use of the 3D general replica 402 and the 3D ultrasound replica 401 allows the surgeon to better plan, prepare and/or practice a surgical technique with the additional information provided by the addition of the 3D general replica 402. The 3D general digital model and the 3D ultrasound digital model can be constructed using a combination of image segmentation software and basic CAD software (which can be used to configured processing circuitry 603) to export a file compatible with the preferred method of rapid prototyping. The image segmentation software and basic CAD software can be run by using processing circuitry 603, which is described with reference to FIG. 6.

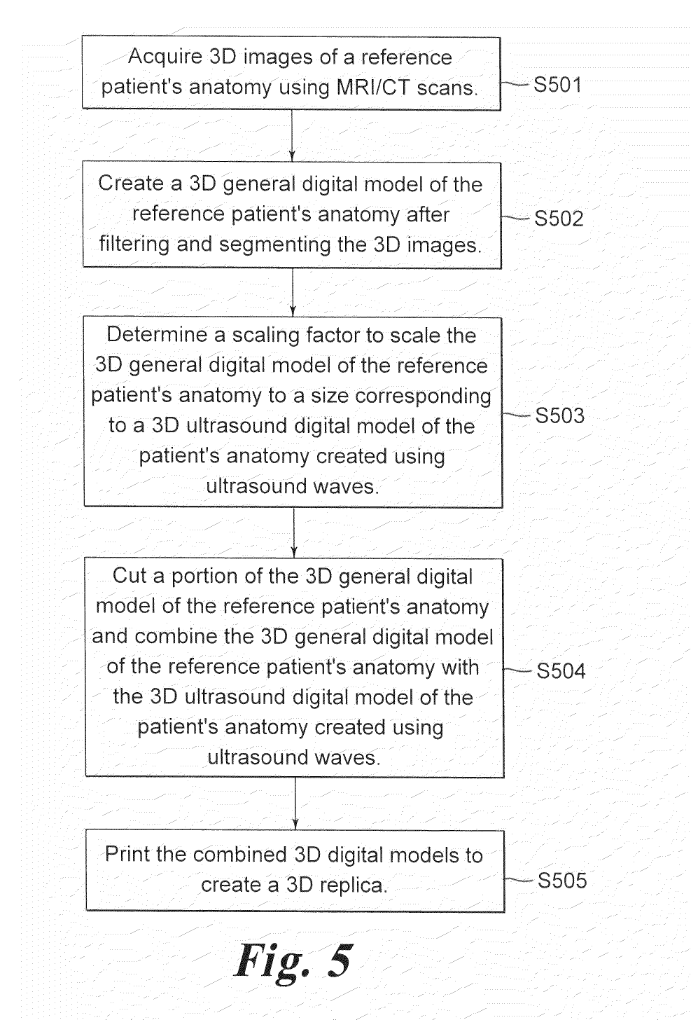

The method of generating a 3D ultrasound replica 401 and a 3D general replica 402 is described below and illustrated in an exemplary flowchart in FIG. 5. In Step S501 of FIG. 5, 3D images of a reference patient's anatomy are acquired using MRI/CT scans. Step S501 may be performed by a 3D image scanner 602 described with reference to FIG. 6. In Step S502 of FIG. 5, a 3D general digital model of the reference patient's anatomy is created after filtering and segmenting the 3D images acquired from MRI/CT scans. The filtering and segmenting of the 3D images can be performed by processing circuitry 603. After creating a 3D general digital model of the reference patient's anatomy and a 3D ultrasound digital model (see description above for generating a 3D digital model using ultrasound waves) of a patient's anatomy, a scaling factor is determined to scale the size of the 3D general digital model to the size of the 3D ultrasound digital model in Step S503 of FIG. 5. For example, as noted above, if the 3D ultrasound digital model is a portion of a heart and the 3D general digital model is an entire heart, a scaling factor is determined based on the size of the portion of the heart in the 3D ultrasound digital model and a corresponding size of the same portion of the heart in the 3D general digital model.

Once the 3D general digital model has been scaled by the processing circuitry 603 (described with reference to FIG. 6), a portion of the 3D general digital model is cut off (the portion corresponding to the 3D ultrasound digital model) and the 3D general digital model is combined with the 3D ultrasound digital model in Step S504 of FIG. 5. Steps S502, S503, and S504 can be performed by processing circuitry 603 (for example, a central processing unit), described with reference to FIG. 6. Finally, in Step S505, the combined 3D digital models are printed using a 3D printer 610 (described with reference to FIG. 6) to generate a combined 3D ultrasound replica 401 and 3D general replica 402, as illustrated in FIG. 4. Alternatively, as noted above, the 3D ultrasound replica 401 and the 3D general replica 402 can be printed separately and can be fit together afterwards.

In another example, a heart with a VSD can be segmented and printed, and the defect itself can be segmented as well. Based on the size and shape of the segmented defect, a plastic replica can be created to simulate a “patch” for the defect. This can also assist in surgical planning, and has the potential to decrease cardiopulmonary bypass time and therefore surgical outcome. Another example is with patients who have undergone placement of a mechanical heart valve and have some leaking of blood around the outside of the valve (perivalvar leak). These areas can be identified using ultrasound waves, can be segmented, and can be printed using the above-described techniques to guide interventional placement of devices to plug these leaks.

Additionally, certain different plastic materials can be used to print a patient's anatomy to enhance functionality. In one aspect, a semi-soft material to allow surgeons to practice suturing on the replicas may be used. In another aspect, a rigid plastic material for replicas of anatomy, where dimensional accuracy is important, may be used. With the newer 3D printing technologies, different sections of the object of interest can be printed with different materials, thereby changing the compliance in various regions. This can make the model feel more appropriate to the surgeon since organs and tissues can have varied physical properties in different regions of the organs and tissues. Alternatively these models may be made in various colors and levels of transparency. In other words, different sections of the object of interest can be printed with different colors and/or with different levels of transparency. Using different materials, different colors, and different levels of transparency for difference sections of the object of interest allows a surgeon to differentiate between different sections of a particular anatomy. Additionally using finishing techniques such as electro-polishing, completely clear plastics can be obtained so that internal features are easily seen. Other materials frequently used in 3D printing include but are not limited to: High-impact plastics, High-temperature plastics, Rubber-like materials, Silicones, Biodegradable polymers, Biocompatible polymers, Bioactive materials, Biologic materials, Ceramics, Fused powders, Metals, Flexible hard plastics, and Bone-like composites.

FIG. 6 illustrates a system for creating a 3D replica of a patient's anatomy. The system in FIG. 6 includes a 3D image scanner using ultrasound waves 601, a 3D image scanner using MRI/CT scans 602, processing circuitries 603 and 607 (for example, a central processing unit), display units 604 and 608, databases 605 and 609, a network 606, and a 3D printer 610. Processing circuitries 603 and 607 can be a single device, multiple devices or a chipset.

The 3D image scanners 601 and 602 acquire 3D images using either ultrasound or MRI/CT scans (see Steps S101 and S501 in FIGS. 1 and 5, respectively). Additionally, processing circuitry 603 receives 3D images from 3D image scanners 601 and 602 and processes these 3D images. Specifically, the processing circuitry 603 selects a filter to filter 3D echo images acquired from 3D image scanner 601, filters the 3D echo images, selects an initial segmentation algorithm to segment 3D echo images, initially segments the 3D echo images, selects one or more subsequent segmentation algorithm(s) to segment the initially segmented 3D echo images based on image intensity, image features, and clinical knowledge, and subsequently segments the initially segmented 3D images (see Steps S102 and S103 in FIG. 1). Further, the processing circuitry 603 creates a 3D digital ultrasound model based on the 3D echo images (see Step S104 in FIG. 1). The 3D echo images (before/after filtering and segmenting) and the 3D ultrasound digital models can be displayed on display 604. Further, 3D echo images (filtered, unfiltered, segmented, and unsegmented) and 3D ultrasound digital models can be stored in a database 605, as illustrated in FIG. 6.

The processing circuitry 603 also receives 3D images from the 3D image scanner 602. These 3D images are acquired using MRI/CT scans. The processing circuitry 603 creates a 3D general digital model with respect to the 3D images received from the 3D scanner 602 after filtering and segmenting these 3D images. The segmenting and filtering of the 3D images is performed by processing circuitry 603 (see Step S502 in FIG. 5). The processing circuitry 603 also determines a scaling factor and scales the 3D general digital model of a reference patient's anatomy to a size corresponding to a 3D ultrasound digital model of a patient's anatomy (the 3D ultrasound digital model is created using 3D echo image received from 3D image scanner 601) (see Step S503 in FIG. 5). For example, as noted above, if the 3D ultrasound digital model is a portion of a heart and the 3D general digital model is an entire heart, a scaling factor is determined based on the size of the portion of the heart in the 3D ultrasound digital model and a corresponding size of the same portion of the heart in the 3D general digital model. Further, the processing circuitry 603 also cuts a portion of the 3D general digital model and combines the 3D general digital model with the 3D ultrasound digital model (see Step S504 in FIG. 5).

Additionally, processing circuitry 607 can perform similar functions to that performed by processing circuitry 603 and therefore, for the sake of brevity, a detailed description of processing circuitry 607 is not provided. Database 609 can also perform functions similar to that performed by database 605, and therefore, for the sake of brevity, a detailed description of database 609 is not provided. Display 608 can also perform functions similar to that performed by display 604 and therefore, for the sake of brevity, a detailed description of display 608 is not provided. Network 606 can be any network, including but not limited to a local area network (LAN), wide area network (WAN), personal area network (PAN), campus area network (CAN), metropolitan area network (MAN), or global area network (GAN) for communication between processing circuitries 603 and 607. Finally, a 3D printer 610 is provided in FIG. 6 to print the 3D digital models into physical 3D replicas of a patient's anatomy (see Steps S104 and S505 in FIGS. 1 and 5, respectively).

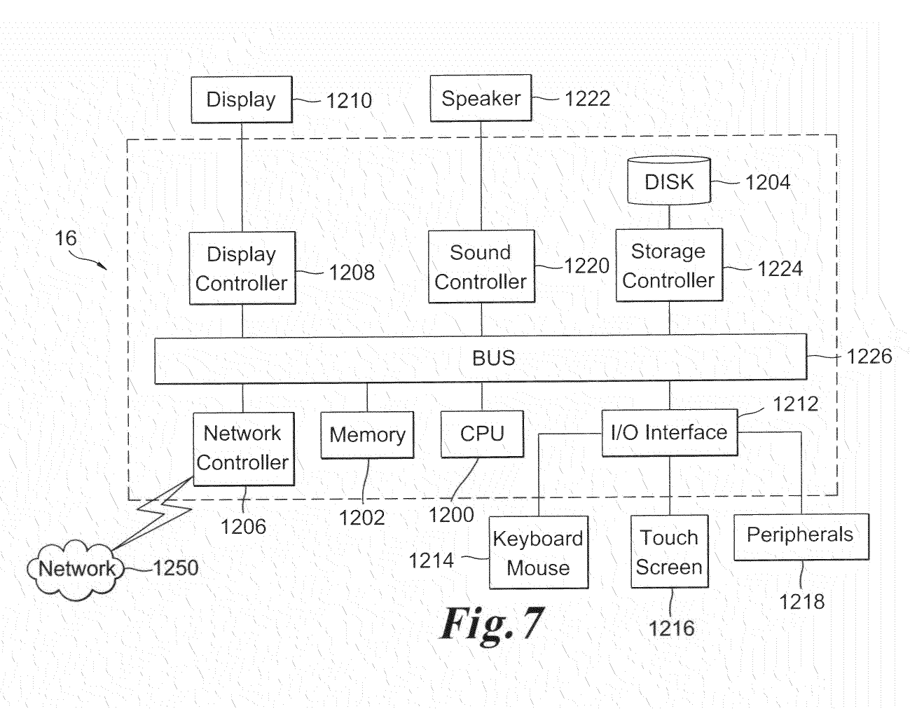

Next, a hardware description of the system according to exemplary embodiments is described with reference to FIG. 7. In FIG. 7, the computer 16 includes a CPU 1200 which performs the processes described above. The process data and instructions may be stored in memory 1202. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the system communicates, such as a server or computer.

Further, the claimed advancements may be provided as a utility application, background daemon, or component of an operating system, or combination thereof, executing in conjunction with CPU 1200 and an operating system such as Microsoft Windows 7, UNIX, Solaris, LINUX, Apple MAC-OS and other systems known to those skilled in the art.

CPU 1200 may be a Xenon or Core processor from Intel of America or an Opteron processor from AMD of America, or may be other processor types that would be recognized by one of ordinary skill in the art. Alternatively, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the inventive processes described above.

The computer 16 in FIG. 7 also includes a network controller 1206, such as an Intel Ethernet PRO network interface card from Intel Corporation of America, for interfacing with network 1250. As can be appreciated, the network 1250 can be a public network, such as the Internet, or a private network such as an LAN or WAN network, or any combination thereof and can also include PSTN or ISDN sub-networks. The network 1250 can also be wired, such as an Ethernet network, or can be wireless such as a cellular network including EDGE, 3G and 4G wireless cellular systems. The wireless network can also be WiFi, Bluetooth, or any other wireless form of communication that is known.

The computer 16 further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computer 16, such as Sound Blaster X-Fi Titanium from Creative, to interface with speakers/microphone 1222 thereby providing sounds and/or music. The speakers/microphone 1222 can also be used to accept dictated words as commands for controlling the robot-guided medical procedure system or for providing location and/or property information with respect to the target property.

The general purpose storage controller 1224 connects the storage medium disk 1204 with communication bus 1226, which may be an ISA, EISA, VESA, PCI, or similar, for interconnecting all of the components of the robot-guided medical procedure system. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

Obviously, numerous modifications and variations of the present disclosure are possible in light of the above teachings. It is therefore to be understood that within the scope of the appended claims, the invention may be practiced otherwise than as specifically described herein. For example, advantageous results may be achieved if the steps of the disclosed techniques were performed in a different sequence, if components in the disclosed systems were combined in a different manner, or if the components were replaced or supplemented by other components. The functions, processes, and algorithms described herein may be performed in hardware or software executed by hardware, including computer processors and/or programmable processing circuits configured to execute program code and/or computer instructions to execute the functions, processes, and algorithms described herein. A processing circuit includes a programmed processor, as a processor includes circuitry. A processing circuit also includes devices such as an application specific integrated circuit (ASIC) and conventional circuit components arranged to perform the recited functions.

The functions and features described herein may also be executed by various distributed components of a system. For example, one or more processors may execute these system functions, wherein the processors are distributed across multiple components communicating in a network. The distributed components may include one or more client and/or server machines, in addition to various human interface and/or communication devices (e.g., display monitors, smart phones, tablets, personal digital assistants (PDAs)). The network may be a private network, such as a LAN or WAN, or may be a public network, such as the Internet. Input to the system may be received via direct user input and/or received remotely either in real-time or as a batch process. Additionally, some implementations may be performed on modules or hardware not identical to those described. Accordingly, other implementations are within the scope that may be claimed.

It must be noted that, as used in the specification and the appended claims, the singular forms “a,” “an,” and “the” include plural referents unless the context clearly dictates otherwise.

While certain embodiments have been described, these embodiments have been presented by way of example only, and are not intended to limit the scope of the inventions. Indeed, the novel methods, apparatuses and systems described herein can be embodied in a variety of other forms; furthermore, various omissions, substitutions and changes in the form of the methods, apparatuses and systems described herein can be made without departing from the spirit of the inventions. The accompanying claims and their equivalents are intended to cover such forms or modifications as would fall within the scope and spirit of the inventions.

1. A method of creating a 3-dimensional (3D) replica of a patient's anatomy, the method comprising:
acquiring 3D echo images of the patient's anatomy using ultrasound waves and using specific acquisition parameters that optimize a quality of the 3D echo images of the patient's anatomy;
selecting, using processing circuitry, a filter based on a type of the patient's anatomy that reduces noise in the 3D echo images by filtering the 3D echo images using the selected filter;
selecting, using the processing circuitry, a segmentation algorithm to segment the filtered 3D echo images;
segmenting each of the filtered 3D echo images; and
creating a 3D digital model of the segmented 3D echo images.

2. The method of creating the 3D replica according to claim 1, further comprising:
outputting the 3D digital model as the 3D replica of the patient's anatomy,
wherein the outputting further includes one of:
printing, using a 3D printer, the 3D digital model as the 3D replica of the patient's anatomy, and
displaying, on a display, the 3D digital model as the 3D replica of the patient's anatomy.

3. The method of creating the 3D replica according to claim 1, further comprising:
selecting, using the processing circuitry, an additional segmentation algorithm to subsequently segment the segmented 3D echo images;
subsequently segmenting each of the segmented 3D echo images; and
creating a second 3D digital model of the subsequently segmented 3D echo images.

4. The method of creating the 3D replica according to claim 1, wherein said segmenting each of the filtered 3D echo images includes:
initially segmenting each of the filtered 3D echo images; and
subsequently segmenting each of the initially segmented 3D echo images.

5. The method of creating the 3D replica according to claim 1, further comprising:
smoothing, wrapping, and hole-filling the segmented 3D echo images prior to said creating the 3D digital model.

6. The method of creating the 3D replica according to claim 1, wherein the patient's anatomy includes a heart or a portion of the heart, and
wherein the specific acquisition parameters include imaging of the heart or the portion of the heart in one phase of a cardiac cycle.

7. The method of creating the 3D replica according to claim 1, wherein said selecting the filter includes selecting at least one of a spatial, frequency, and wavelet filter to reduce noise in the 3D echo images.

8. The method of creating the 3D replica according to claim 1, wherein the segmentation algorithm is selected based on one of a size of the patient, a quality determination of the filtered 3D echo images, and a type of defect of the patient's anatomy.

9. The method of creating the 3D replica according to claim 1, wherein the segmentation algorithm is one of simple threshold, region growing, dynamic region growing, manual segmentation, and image interpolation.

10. The method of creating the 3D replica according to claim 1, wherein the patient's anatomy includes a heart or a portion of the heart, and wherein said selecting the segmentation algorithm to segment the 3D echo images is based on a heart rate of the patient.

11. The method of creating the 3D replica according to claim 3, wherein the additional segmentation algorithm is one or more of thresholding, region growing, dynamic region growing, and hand-segmentation.

12. The method of creating the 3D replica according to claim 1, wherein the segmented 3D echo images are converted to a StereoLithography-file (STL-file) format.

13. The method of creating the 3D replica according to claim 2, wherein different sections of the patient's anatomy are printed with different materials, different colors, and/or different levels of transparency.

14. The method of creating the 3D replica according to claim 2, further comprising
electro-polishing or post-processing the 3D replica of the patient's anatomy to clarify internal features of the 3D replica of the patient's anatomy.

15. The method of creating the 3D replica according to claim 13, wherein the different materials includes one or more of High-impact plastics, High-temperature plastics, Rubber-like materials, Silicones, Biodegradable polymers, Biocompatible polymers, Bioactive materials, Biologic materials, Ceramics, Fused powders, Metals, Flexible hard plastics, and Bone-like composites.

16. The method of creating the 3D replica according to claim 1, wherein the segmentation algorithm is manual, semi-automated, and/or automated.

17. The method of creating the 3D replica according to claim 1, further comprising:
acquiring other 3D images of a reference patient's anatomy using MRI/CT scans, the reference patient's anatomy corresponding to the patient's anatomy;
creating, using processing circuitry, another 3D digital model of the other 3D images after filtering and segmenting the other 3D images;
determining, using the processing circuitry, a scaling factor to scale a first size of the another 3D digital model of the reference patient's anatomy to correspond to a second size of the 3D digital model of the patient's anatomy;
scaling, using the processing circuitry, the first size of the another 3D digital model using the scaling factor;
cutting, using the processing circuitry, a first portion of the another 3D digital model, the first portion corresponding to the patient's anatomy represented by the 3D digital model, and replacing the first portion with the 3D digital model by combining the 3D digital model and the another 3D digital model; and
outputting the combined another 3D digital model and 3D digital model to generate a combined 3D replica of the patient's anatomy.

18. The method of creating the 3D replica according to claim 17,
wherein the outputting further includes one of:
printing, using a 3D printer, the combined 3D replica of the patient's anatomy, and
displaying, on a display, the combined another 3D digital model and 3D digital model as the 3D replica of the patient's anatomy, and
wherein the another 3D digital model and the 3D digital model are printed using different materials.

19. The method of creating the 3D replica according to claim 18, wherein the another 3D digital model is printed using a transparent material and the 3D digital model is printed using an opaque material, or wherein the another 3D digital model is printed using the opaque material and the 3D digital model is printed using the transparent material.

20. A device for creating a 3-dimensional (3D) replica of a patient's anatomy, the device comprising:
processing circuitry configured to:
select a filter based on a type of the patient's anatomy that reduces noise in 3D echo images of the patient's anatomy by filtering the 3D echo images using the selected filter, the 3D echo images being acquired from a first 3D scanning apparatus using ultrasound waves;
select a segmentation algorithm to segment the filtered 3D echo images;
segment each of the filtered 3D echo images; and
create a 3D digital model of the segmented 3D echo images.

21. The device for creating the 3D replica according to claim 20, wherein the processing circuitry is further configured to:
select an additional segmentation algorithm to subsequently segment the segmented 3D echo images;
subsequently segment each of the segmented 3D echo images; and
create a second 3D digital model of the subsequently segmented 3D echo images to be output as the 3D replica of the patient's anatomy.

22. The device for creating the 3D replica according to claim 20, wherein the processing circuitry is further configured to:
create another 3D digital model of other 3D images of a reference patient's anatomy after filtering and segmenting the other 3D images, the reference patient's anatomy corresponding to the patient's anatomy and the other 3D images being acquired from a second 3D scanning apparatus using MRI/CT scans,
determine a scaling factor to scale a first size of the another 3D digital model of the reference patient's anatomy to correspond to a second size of the 3D digital model of the patient's anatomy,
scale the first size of the another 3D digital model using the scaling factor, and
cut a first portion of the another 3D digital model, the first portion corresponding to the patient's anatomy represented by the 3D digital model, and replace the first portion with the 3D digital model by combining the 3D digital model and the another 3D digital model to output the combined other 3D digital model and 3D digital model as a combined 3D replica of the patient's anatomy.

23. The method of creating the 3D replica according to claim 4, wherein different portions of the patient's anatomy are subsequently segmented using different segmentation algorithms.

24. The device of for creating the 3D replica according to claim 21, wherein different portions of the patient's anatomy are subsequently segmented using different segmentation algorithms.

25. A non-transitory computer-readable storage medium storing computer-readable instructions that, when executed by a computer, cause the computer to execute a method of creating a 3-dimensional (3D) replica of a patient's anatomy comprising:
acquiring 3D echo images of the patient's anatomy using ultrasound waves and using specific acquisition parameters that optimize a quality of the 3D echo images of the patient's anatomy;
selecting, using processing circuitry, a filter based on a type of the patient's anatomy that reduces noise in the 3D echo images by filtering the 3D echo images using the selected filter;
selecting, using the processing circuitry, a segmentation algorithm to segment the filtered 3D echo images;
segmenting each of the filtered 3D echo images; and
creating a 3D digital model of the segmented 3D echo images.
